(19) United States
(12) Patent Application Publication
(10) Pub. No.: US 2003/0181228 A1
(43) Pub. Date: Sep. 25, 2003

(54) Folder type mobile communication terminal having a touch screen and a functional key on the outside of an upper folder

(76) Inventor: Hyung-Kwon Kim, Bucheon (KR)

Correspondence Address: MORGAN & FINNEGAN, L.L.P., 345 Park Avenue, New York, NY, 10154-0053, US

(21) Appl. No.: 10/313,628

(22) Filed: Dec. 6, 2002

(30) Foreign Application Priority Data
Dec. 7, 2001 (KR) 2001-77205

(51) Int. Cl. H04M 1/00

(52) U.S. Cl. 455/575.3; 455/575.1

(57) ABSTRACT

The present invention provides a folder type mobile communication terminal with a touch screen and a functional key on the outside of an upper folder, allowing a user to view displayed information and select by touching the screen various menu items or perform functions without unfolding the upper folder, thus, enhancing the convenience of use of the folder type mobile communication terminal.

### FIELD OF THE INVENTION

The present invention relates to a folder type mobile communication terminal including a main body and an upper folder assembled in a foldable manner to the main body on the axis of a hinge part, with touch screen and function keys installed on the outside of the upper folder.

### DESCRIPTION OF THE PRIOR ART

As the information and telecommunication industries rapidly grow, the types and functions of mobile communication terminals such as a mobile phone and personal digital assistant (PDA) also diversify triggering a rapid increase in the number of users of such mobile communication terminals. Mobile phones of various types are provided such as a bar type, a flip type, a sliding type and a folder type, of which the folder type mobile phones are gaining most popularity recently due to their small size and light weight as well as their large display space allowing more information to be displayed.

However, since a conventional folder type mobile communication terminal is designed to be folded while not in use or in a call-waiting status with its display part hidden, the terminal does not allow a user to view the display part in a folded state. A problem with such mobile communication terminal is that information displayed on the display part can be confirmed only when the upper folder is unfolded by a user. Accordingly, it is inconvenient when a user wishes to view information on the display part frequently for information such as sensitivity of signal receiving, remaining battery, present time, date, and the like.

A dual display type mobile communication terminal have been introduced to improve the shortcomings of the conventional folded type terminal. The dual display type terminal is equipped with an additional display part on the outside of the upper folder allowing a user to view information even when the upper folder is in a folded state.

FIG. 1A shows a conventional dual display type mobile communication terminal 100 with its upper folder unfolded. The total size of the dual display type mobile terminal is minimized for carriage or storage by folding the upper folder, while the upper folder is unfolded when the phone is used where the signal input buttons and the main display part are exposed externally.

The dual display type terminal includes a main body 110 and an upper folder 120 which is assembled to the main body in a foldable manner on the axis of a hinge 124 provided at the upper part of the main body. The main body 110, on its front surface, includes signal input buttons 112 for inputting signals (e.g., numerals, letters, etc) and a transmission part 114 for transmitting the inputted signals. The upper folder 120, on its front surface, includes a main display part 130 for displaying information such as sensitivity of signal receiving (i.e., signal strength) 131, remaining battery charge 132, present time 133, date 134, user name 135 and a menu icon 136 for displaying various menu items.

FIG. 1B shows a conventional dual display type mobile communication terminal with its upper folder folded. The dual display type mobile terminal includes a secondary display part on its outside of the upper folder. Information such as signal strength 131, remaining battery charge 132, present time 133, date 134 may be displayed on the secondary display part allowing a user to view such information without unfolding the upper folder.

The secondary display part of a conventional dual display type mobile communication terminal, however, does not allow a user to input information while watching the assistant display part. Furthermore, since the signal input buttons are provided only on the inside of the mobile communication terminal, the upper folder needs to be unfolded every time when information needs to be inputted.

### SUMMARY OF THE INVENTION

The present invention, conceived in view of the afore-mentioned problems, aims to provide a folder type mobile communication terminal consisting of a main body and an upper folder assembled in a foldable manner to the main body on the axis of a hinge part, having touch screen and functional keys installed on the outside of the upper folder.

In order to achieve the above objectives, a folder type mobile communication terminal of the present invention having a main body and an upper folder assembled in a foldable manner to the main body on the axis of a hinge part is equipped with, on the outside of the upper folder, a touch screen capable of displaying information as well as receiving input information and functional keys such as direction keys and selection keys.

In accordance with one aspect of the invention, an exemplary mobile communication terminal of the present invention includes: a main body having a signal input part for inputting information and a signal transmission part for transmitting a signal based on the information inputted from the signal input part; and an upper folder, assembled in a foldable manner to said main body on the axis of a hinge part, having a touch screen disposed on the outside of the upper folder, wherein the touch screen is configured to display status information and receive input information when the folder is in the folded position.

Other and further aspects of the present invention will become apparent during the course of the following detailed description and with reference to the attached drawings.

### BRIEF DESCRIPTION OF THE DRAWINGS

FIG. 1A shows a conventional dual display type mobile communication terminal with its upper folder unfolded;

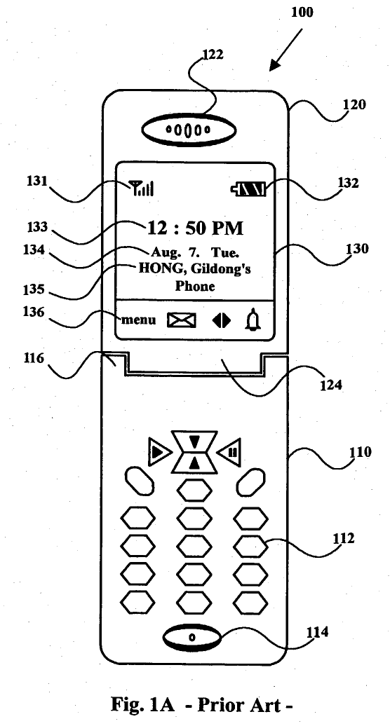

FIG. 1B shows a conventional dual display type mobile communication terminal with its upper folder folded; and

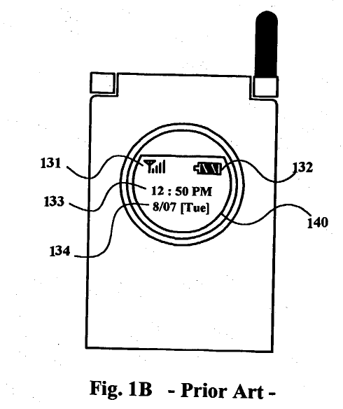

FIG. 2 shows a folder type mobile communication terminal according to one embodiment of the present invention with its upper folder folded showing an external screen and function keys on the outside of upper folder.

### DETAILED DESCRIPTION OF THE INVENTION

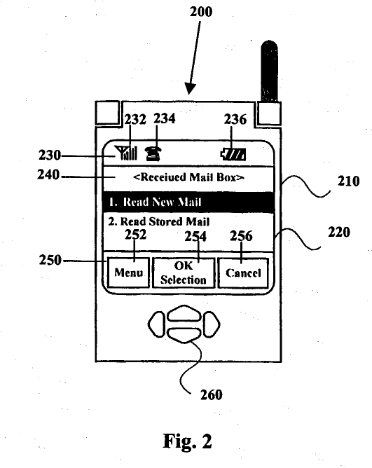

FIG. 2 is an exemplary folder type mobile communication terminal 200 according to the present invention with its upper folder 210 folded. The folder type mobile communication terminal of the present invention is provided with an outside screen 220. The outside screen of the terminal of the present invention is configured to display information and further configured to input signals as well.

Providing many signal input buttons on the outside of an upper folder of a folder type mobile communication terminal where an assistant display part displays information may be problematic not only because of the insufficient space available on the upper folder, but also the fear of inadvertent actuation, since the above signal input buttons are exposed externally when the upper folder is in a folded state.

This problem can be solved by installing a touch screen on the outside of the upper folder that can display information externally and at the same time allows inputting information through it so that the touch screen functions as an assistant display part as well as the signal input mechanism, enabling displaying the information and input signals without unfolding the upper folder.

A touch screen is a screen allowing a direct input of data through the screen without using a separate input device. A touch screen, being a functional combination of a general display screen and a touch panel, functions to recognize a touched location on the screen. The touch screen generates invisible infrared rays forming a matrix grid to enable detection of contacted various screen positions. Thus, if a letter or image information displayed on the touch screen is touched with a finger or other object, the touch screen recognizes what the user has selected (i.e., by which portion of the grid is touched) and controls to process the corresponding order. A user may simply touch a letter or a specific location displayed on the screen with a finger or other object. The screen then recognizes the touched location and processes the input data with preinstalled software.

Referring to FIG. 2, outside screen 220 of terminal 200 may be divided into several other functional areas. In an embodiment, the outside screen is built with a touch screen and divided into a status information display part 230, a mail box organizer 240 and a functional key display part 250. The status information such as reception signal sensitivity 232, a call waiting indicator 234 and battery status 236 may be displayed in the status information display part. The mail box organizer may display selections for organizing the mail box. The functional key display part may include “buttons” such as a menu button 252, an okay selection button 254 and a cancel button 256. Specifically, the functional key display part is configured to receive input signals from a user by a touch of the displayed buttons. A user may touch an appropriate button with a part of his body (e.g., a finger) or any other object, for example, to select a menu displayed on the touch screen. Alternatively, other parts of the screen such as the status information display part and mail box organizer may also be configured to receive input signal by being touched allowing more sophisticated information to be inputted and displayed. The outside screen of the terminal of the present invention may be further configured to display instant information inputted by a user using a button of the touch screen while the upper folder of the terminal is in a folded state. Additionally, the outside screen may also include regular functional keys 260 (e.g., a direction key, a selection key, a send key, an end key) outside the touch screen for inputting signals based on the information displayed on the touch screen.

An inside screen (not shown) of terminal 200 may display similar information to outside screen 200. A touch screen may also be used to build the inside screen enabling a user to input signal by touching a portion of the screen.

The other internal construction of the folder type mobile communication terminal of the present invention is similar to that of a conventional folder type mobile communication terminal and descriptions in these respects are omitted.

In summary, a folder type mobile communication terminal of the present invention provided with a secondary touch screen and functional keys on the outside of its upper folder allows a user to select various menu items or perform other necessary functions using the touch screen and the function keys on the outside of the upper folder without unfolding the upper folder.

Although the present invention has been described above with reference to a preferred embodiment, the scope of the rights of the subject invention is not restricted thereto, but rather shall be determined by the claims attached herein below and their equivalents, allowing various alterations, modifications, and adjustments, as those skilled in the art will understand. Though the present invention has been described above for the case of a mobile phone, the invention applies to all mobile communication terminals such as a PDA.

What is claimed is:

1. A folder type mobile communication terminal comprising:
a main body having a signal input part for inputting information and a signal transmission part for transmitting a signal based on the information inputted from the signal input part; and
an upper folder, assembled in a foldable manner to said main body on the axis of a hinge part, having a touch screen disposed on outside of the upper folder,
wherein the touch screen is configured to display status information and receive input information.

2. The folder type mobile communication terminal of claim 1, wherein the status information includes at least one of a reception signal sensitivity, a call waiting indication and a battery status.

3. The folder type mobile communication terminal of claim 1, wherein the input information includes at least one of a selection signal selected from a menu displayed on the touch screen.

4. The folder type mobile communication terminal of claim 3, wherein the selection signal is an externally inputted signal from a user.

5. The folder type mobile communication terminal of claim 1, wherein said upper folder further comprises on the outside thereof one or more regular functional keys for inputting signals.

6. A method of using a folder type mobile communication terminal comprising:
receiving a signal inputted from a user by using a touch screen disposed on an outside of an upper folder of the folder type mobile communication terminal;
processing the inputted signal from the user using a software installed on the folder type mobile communication terminal; and
displaying information on the touch screen based on the processed signal.
